(19) United States
(12) Patent Application Publication
(10) Pub. No.: US 2019/0156307 A1
(43) Pub. Date: May 23, 2019

(54) AGENT ACCESS PORTAL TO MONEY TRANSFER SYSTEM

(71) Applicant: MoneyGram International, Inc., Dallas, TX (US)

(72) Inventors: Eric J. Sander, Mendota Heights, MN (US); Peter E. Ohser, Maple Grove, MN (US); Bart J. Davis, Lakeville, MN (US); James M. Henry, River Falls, WI (US)

(21) Appl. No.: 16/250,562

(22) Filed: Jan. 17, 2019

Related U.S. Application Data
(63) Continuation of application No. 13/669,143, filed on Nov. 5, 2012.
Application No. 13/669,143 is a continuation of application No. 12/257,120, filed on Oct. 23, 2008, now abandoned.
(60) Provisional application No. 61/106,090, filed on Oct. 16, 2008.

(51) Int. Cl. G06Q 20/10; G06Q 50/20; G06Q 40/02; G06Q 10/06; G06Q 40/00

(52) U.S. Cl. CPC G06Q 20/10; G06Q 50/2057; G06Q 40/00; G06Q 10/0633; G06Q 10/06398; G06Q 40/02

(57) ABSTRACT

A method for operating a computer-based processing system to provide money transfer services though user interfaces including agent portals. A plurality of user-specific and/or terminal-specific profiles including money transfer-related services available to a user and/or terminal are stored. Requests to provide money transfer-related services are received from a plurality of terminals operated by users at locations. Profiles associated with the one or more of the users operating the terminals and the locations of the terminals from which the money transfer-related service requests are received are determined. Portals including tabs linking to available money transfer-related services associated with the determined profiles are provided.

### CROSS REFERENCE TO RELATED APPLICATIONS

This application is a continuation of U.S. patent application Ser. No. 13/669,143, filed on Nov. 5, 2012, which is a continuation of U.S. patent application Ser. No. 12/257,120, filed Oct. 23, 2008, now abandoned, which claims priority under 35 U.S.C. § 119(e) to U.S. Provisional Patent Application No. 61/106,090, filed on Oct. 16, 2008, all of which are incorporated herein by reference in their entireties and for all purposes.

### TECHNICAL FIELD

The present invention relates generally to money transfer systems.

### BACKGROUND

Money transfer businesses such as MoneyGram International offer money transfer and other services through a network of agents located all around the world. In most cases, these agents operate businesses which provide other services in addition to money transfer. A customer that desires to transfer money to a third party usually takes the money to an agent of the money transfer business. The agent accepts the money, obtains necessary information such as the customer's identity and the identity of the receiver, and initiates a transaction through a money transfer network. The money is then made available to the receiver by another agent at a different location.

Prior to conducting services on behalf of a money transfer business, agents must be approved and trained (“agent on-boarding”). During the approval process, an applicant submits information to be reviewed and verified. This process typically involves numerous stages and levels of approval and can take a relatively long time period to complete. Largely paper-based processes have been used for the agent on-boarding process. A paper-based on-boarding process can involve a number of different individuals, each of which may review and process different functional aspects before passing the paperwork and associated information on to others in the work flow.

Depending on the location of the agent and the services and products the agent will be providing, various regulations and safeguards must also be met prior to approving and training the agent. There are various federal, state and municipal regulations and requirements for different products. For example, some states or countries may require collection of additional information depending on the amount of money being transferred. In addition, different agents will likely be assigned varying levels of access or privileges depending on the profile of the business, the location, or the transaction volume generated by the system. For example, different agents may have different levels of authorizing power or different levels of access to information. Consequently, there is a need to manage the agent relationship in a manner which takes into account these different levels.

There is therefore a need for a system capable of managing the relationship between a money transfer business and its agents.

### SUMMARY

One embodiment of the invention is a method for operating a computer-based processing system to provide money transfer services though user interfaces including agent portals. The method comprises storing a plurality of user-specific and/or terminal-specific profiles including money transfer-related services available to a user and/or terminal; receiving, from a plurality of terminals operated by users at locations, requests to provide money transfer-related services; determining the profiles associated with the one or more of the users operating the terminals and the locations of the terminals from which the money transfer-related service requests are received; and providing portals including tabs linking to available money transfer-related services associated with the determined profiles. In another embodiment of the invention storing profiles includes storing profiles including one or more of bill pay and money transfer services; and providing portals includes providing portals including tabs linking to one or more of bill pay and money transfer services.

### BRIEF DESCRIPTION OF THE DRAWINGS

FIG. 1 is a screen shot of an agent portal interface in accordance with one embodiment of the present invention.

FIG. 2 is a block diagram of the components of an agent management system having an agent on-boarding system and agent portal systems in accordance with the present invention.

FIG. 3 is a flow diagram of a subprocess performed using the agent on-boarding system shown in FIG. 2 in accordance with the present invention.

FIG. 4 is a screen shot of a thin client point of sale system interface for a specific deployment in accordance with one embodiment of the present invention.

FIG. 5 is a schematic diagram of a transaction scenario using a kiosk system in accordance with one embodiment of the present invention.

FIG. 6 is a schematic diagram of a transaction scenario using the kiosk system in accordance with one embodiment of the present invention.

FIG. 7 is a screen shot of an agent service system interface with a “chat” feature in accordance with one embodiment of the present invention.

### DETAILED DESCRIPTION

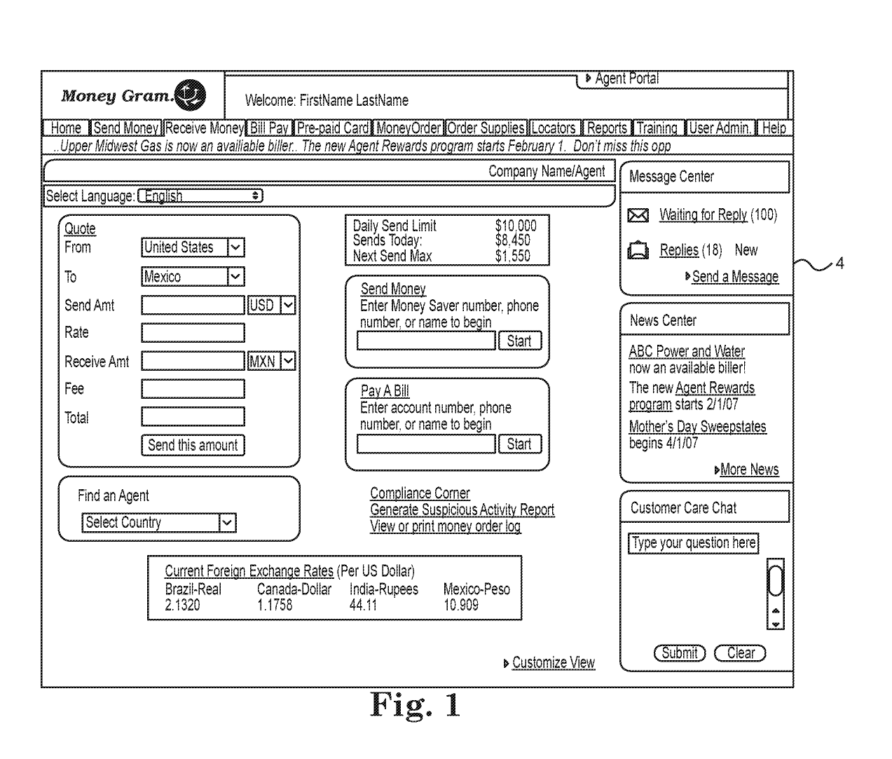

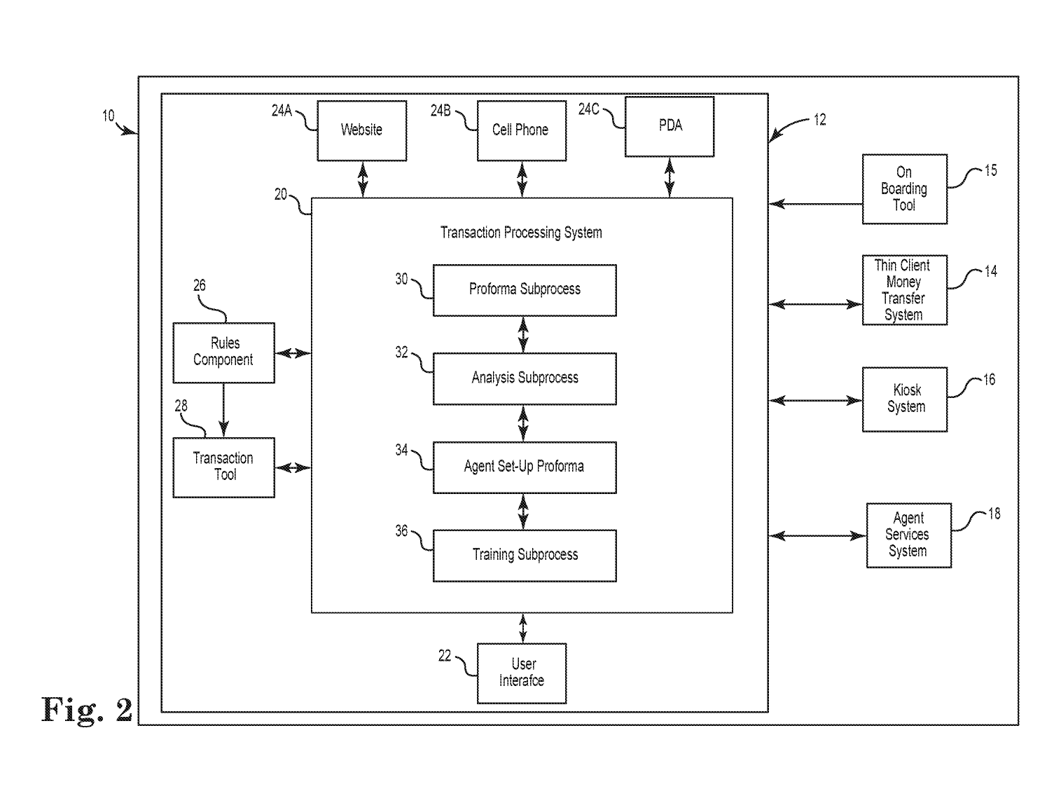

Referring to FIG. 1, in one embodiment, an agent portal 4 is utilized to interface to an agent management system 10 (shown in FIG. 2). The agent portal 4 enables a money transfer business to deliver services and products to its agents. Examples of such services are disclosed in co-pending U.S. patent application Ser. No. 11/846,323 entitled “Consumer Database Loyalty Program for a Money Transfer System” and Ser. No. 11/874,694 entitled “Global Compliance Processing System for a Money Transfer System”, which are herein incorporated by reference. Examples of products include money transfers, bill payments and money orders.

The agent portal 4 provides agents with a platform to use products offered by the money transfer business. As an initial security measure, the agent portal 4 may include an initial setup process in which the agent enters information, such as a username and password, that are validated prior to allowing the agent access to the agent portal 4. A fraud prevention toolkit may also be created that gives independent agents as well as administrators and retailers the ability to deploy a range of additional security features at various administrator levels.

After the agent has signed into the agent portal 4, the agent is directed, in one embodiment, to a standardized interface that presents various options that the agent can choose from, depending on the agent's location or the desired transaction. For example, support is provided for multiple languages with a main page dropdown, allowing the interface to be used in various countries. A preference or previous selection may also be determined by an agent profile. Individual agents may also be allowed to change certain functionalities, such as changing the foreign exchange rate and/or fees to provide more dynamic and competitive pricing. The layout of the interface may include tab navigation to sites determined by administrator preference. In addition, there may also be customizable features, such as color sets and banner graphics for limited custom branding. FIG. 1 shows one embodiment of a screen shot of an agent portal interface including a language selection, numerous tab selections and information specific to a chosen country, such as a daily send limit.

The agent portal 4 provides a multi-level user administration system that allows for both centralized control by the money transfer business as well as agent-level control of users and permissions. For example, there may be options related to country profiles, user levels/roles, permissions management, batch profile management and content management. Under country profiles, agents may control functions and restrictions depending on the location of the agent. Under user levels/roles, the agents are given a specific level of access depending on their job functions. In some embodiments, an agent may be able to view other agent screens and access information on other agents as well as find additional information, add or edit user information, manage subagents and reset passwords. For permissions management, manger-level users have the maximum permissions for their level by default and can control and determine access to various functions. Under batch profile management, the money transfer business may make changes for multiple users at one time. The money transfer business can define what permissions to add or remove and what fields to add to agents at a select level. For content management, a separate system may be used to manage input and publication of content on the interface. For example, information may be posted or reviewed, content may be given display date ranges, and display by portal users may be restricted depending on the agent level or country.

FIG. 2 shows a block diagram of an agent management system 10. The agent portal 4 may be offered at least in three capacities or configurations: thin client point of sale system 14, kiosk system 16 and agent service system 18. Thin client point of sale system 14 allows agents to process transactions with only a web browser and internet access. Kiosk system 16 reduces the burden on the agents and provides a self-serve option for consumers. Agent service system 18 provides a mechanism for agents to receive services such as training, documents, etc. from the money transfer business.

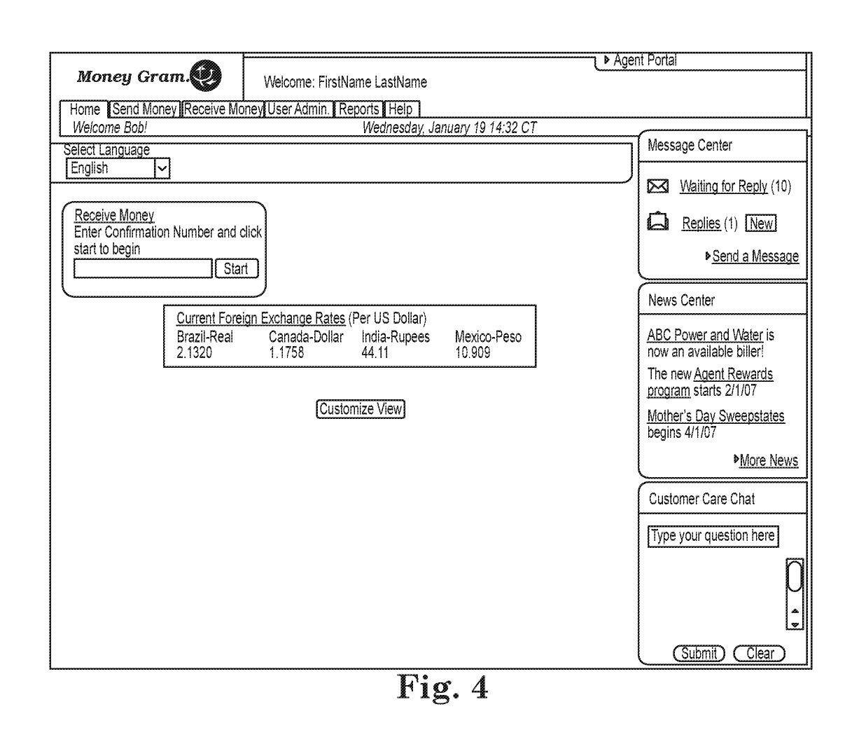

Thin client point of sale system 14 centralizes control of agent accounts by allowing remote management of products which are available to the agents. With thin client point of sale system 14, the agent can access the agent management system 10 from anywhere in the world through a web browser and an internet connection. This provides agents with a flexible platform to retrieve products to provide services to consumers. Because thin client point of sale system 14 is accessible from almost any location, an agent can be mobile and target various areas rather than being tied to a single location. FIG. 4 shows one embodiment of a screen shot of a specific deployment of thin client money transfer system 14 allowing the user to only receive money.

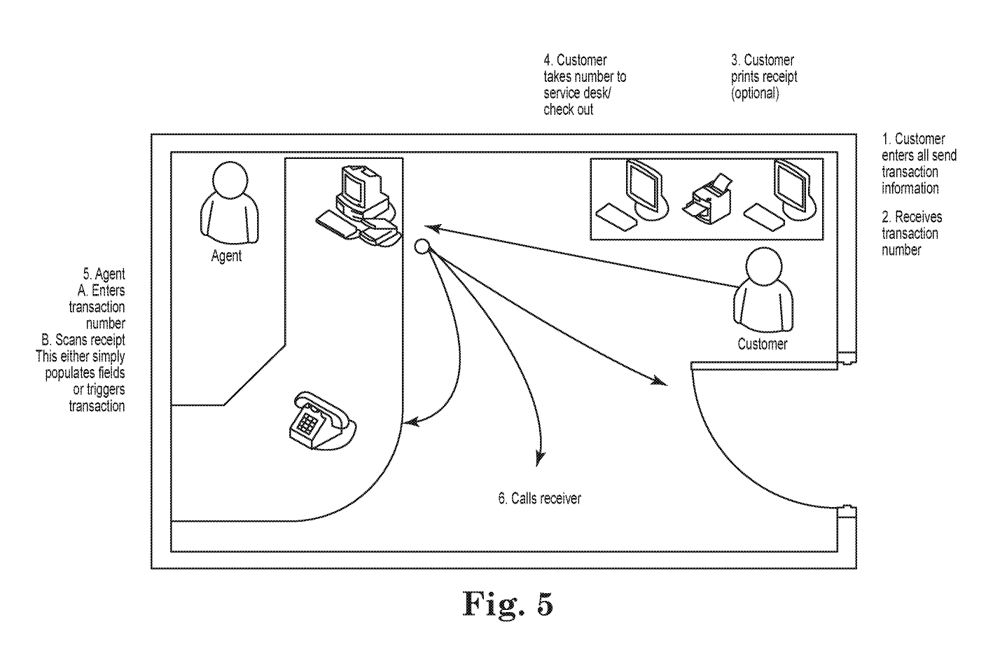

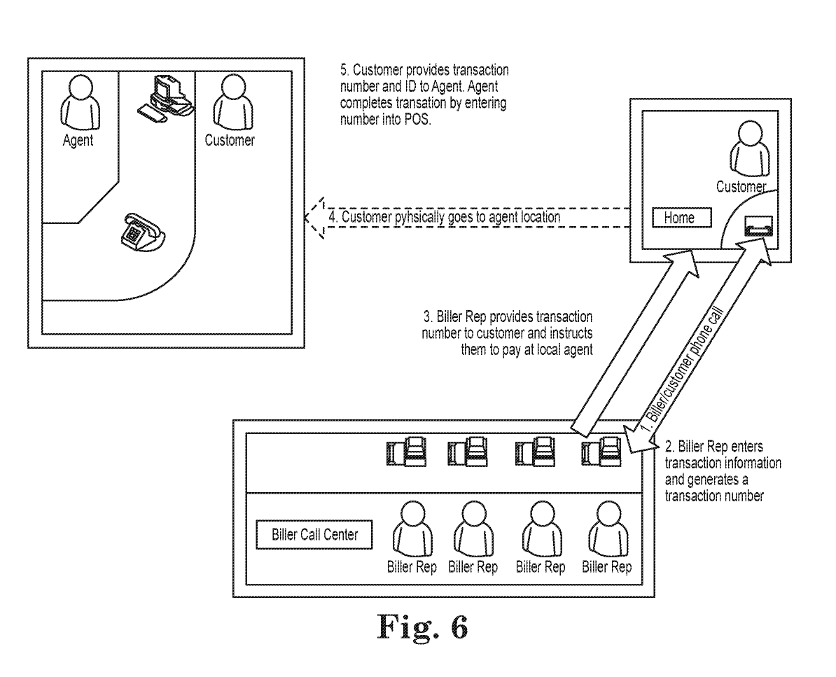

Kiosk system 16 provides a web interface to a consumer and allows the consumer to enter transaction information into the kiosk system 16 at a kiosk prior to interacting with the agent. FIG. 5 shows an exemplary scenario in which an agent at a kiosk can complete a transaction. In the embodiment shown in FIG. 5, after the consumer enters the transaction information into the kiosk, the consumer is given a transaction number, which may be in printed form. The consumer then brings the transaction number to the agent, who enters the transaction number into agent management system 10 to populate the transaction information and complete the transaction. This method simplifies transactions for the agent and provides more efficient processing of consumer information. In an alternative embodiment shown in FIG. 6, the consumer can also enter transaction information on a home computer with internet access or the consumer can provide information to an agent by telephone. Again, after the transaction information has been entered, the consumer is given a transaction number to bring to an agent to complete the transaction.

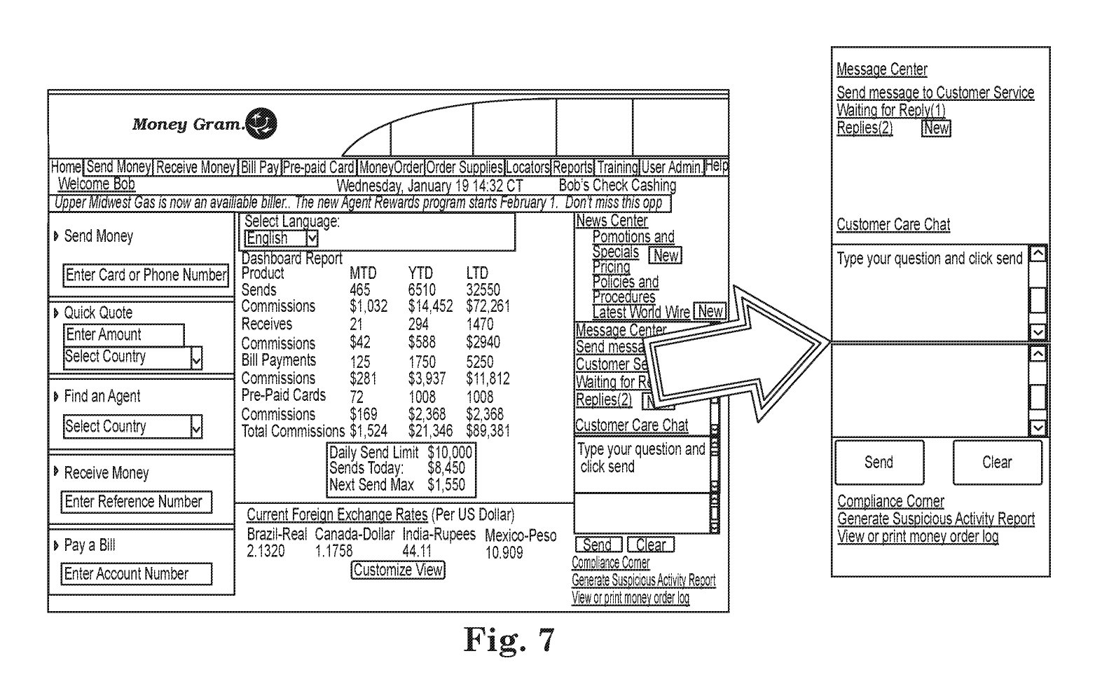

Agent service system 18 consolidates numerous features offered to an agent by the money transfer business into a single portal. For example, the single portal offers efficient delivery of self-service items in order to reduce the number of necessary contacts. The self-service features or items can include, but are not limited to: help features, FAQs, contact information, reports, transaction status and/or searches and training programs. The single portal can also offer alternative service channels in order to reduce telecommunication costs. For example, the single portal can provide an email connection and provide forms for completion and submission on a secure line. In addition to a secure email connection, the agent portal may offer a real-time “chat” feature that allows an agent to communicate with the money transfer business, as shown in FIG. 7.

Through the configurations described above, the agent portal 4 offers the money transfer business a convenient line of communication to either provide information to the agents or to train agents on new products or technologies. On the communications side, because the agent portal 4 integrates with at least the browsers and email system, the money transfer business can simultaneously convey information to all or select agents. In addition, the money transfer business can link into each agent's activities at any given time to either provide support or verify data. By consolidating numerous features into a single portal that allows the agents to directly obtain information they need, costs typically expended by agents using customer and technical support services are saved.

Regarding training, the agent portal 4 provides a mechanism for the money transfer business to offer on-line compliance and functional training to the agents. When new products become available after the agent has completed initial training, continuing training sessions can be offered to educate the agents on the new products. In addition, the government or the money transfer business may require that the agents complete occasional compliance training in order to provide a particular service. The training may be offered to the agents individually, such as through a tutorial, or may be offered to more than one agent at a time, such as through a webcast. By offering the training sessions through the agent portal 4, the agents are not required to travel to a particular location at a particular time and can complete the training on their own time.

As shown in FIG. 2, in one embodiment, the agent management system 10 can include a training subprocess 36 which monitors agent training and enforces training requirements. The training subprocess 36 can download training material and testing programs to the agent portal 4. Once the agent has completed the training material or program, a testing module can also be downloaded to measure the agent's comprehension of the material. An agent that is not compliant with testing requirements can be blocked from accessing other products and services on the agent management system 10 until the agent has satisfied training requirements. Training and testing can be done through the agent portal 4 or through other means of correspondence.

In one embodiment, the agent management system 10 of the present invention includes a centralized agent on-boarding component. This feature enables applicants wishing to be agents to upload applicant information into the agent management system 10 and have it dispersed non-linearly to a group of administrators within the money transfer business. Based on a predetermined set of on-boarding rules, agent applications can be monitored in real-time such that the agent management system 10 can authorize the agent application, decline the agent application, notify the applicant or ask an applicant for more information before deciding on the agent application. Upon processing of the on-boarding rules, an on-boarding response is generated and may include forwarding the agent application, sending the agent application back to the applicant, notifying the applicant or denying the agent application. In addition, the applicant can be notified each time an administrator has responded to the agent application.

As illustrated in FIG. 2, agent management system 10 includes a set of computers and terminals such that substantially all of the work steps performed in conjunction with the agent management system 10 are done by business operation systems. Agent management system 10 includes agent on-boarding system 12 and agent portal configurations including thin client money transfer system 14, kiosk system 16 and agent services system 18 in accordance with one embodiment of the present invention. Agent on-boarding system 12 of agent management system 10 provides a centralized method of administering and managing agent on-boarding and offers a wide range of transactional and service tools by enhancing the agent on-boarding process through the use of electronic forms and imaging. To initiate the agent on-boarding process, an applicant or an originator, such as a sales representative for a money transfer business, first enters information which is then electronically sent to a number of administrators in the money transfer business for review. By using this automated process, uniformity is increased and time-to-market is reduced due to the ability to electronically and simultaneously deliver documentation to multiple administrators. This is accomplished in part by reducing paperwork and the need for departmental tracking tools and overnight packages. As such, agent on-boarding system 12 provides flexibility and scalability and also reduces maintenance costs. For example, in addition to administering and managing agent on-boarding, agent on-boarding system 12 may also be used in various other applications, including, but not limited to: adding new locations, adding new products and processing status changes.

In the embodiment shown in FIG. 2, agent on-boarding system 12 includes a transaction processing system 20, user interface 22, terminals 24A, 24B and 24C, rules component 26 and transaction tool 28. Within transaction processing system 20 is a plurality of subprocesses, including proforma subprocess 30, analysis subprocess 32, agent set-up subprocess 34 and training subprocess 36. Each of subprocesses 30, 32, 34, 36 is managed by transaction processing system 20 which manages the flow of information during agent on-boarding.

As previously mentioned, agents may have varying authorizations and access to information within the agent management system 10. Depending on the risks associated with each agent or agent location, agent on-boarding system 12 sends the agent application through different levels of review in each of subprocesses 30, 32, 34, 36. Subprocesses 30, 32, 34, 36 may also have different variations depending on what services or products the applicant requests to provide to consumers upon approval of agent status. In addition, once the agent application has been approved and the applicant has been trained as an agent, the agent can request various services from the money transfer business. Depending on the services requested, each subprocess 30, 32, 34, 36 will also send the agent application through different variations.

A more detailed description of one embodiment of the various components of agent on-boarding system 12 of the agent management system 10 and its operation follow below.

Transaction Processing System 20

Transaction processing system 20 connects user interface 22, terminals 24A-24C, rules component 26 and transaction tool 28 to subprocesses 30, 32, 34, 36 and collects and transfers data to the appropriate location. Because transaction processing system 20 is linked to all the other components of agent on-boarding system 12, transaction processing system 20 will be discussed in relation to each of the components.

User Interface 22

User interface 22 or agent onboarding tool 15 provides a mechanism for flexible data collection and display, including the ability to collect new fields that do not currently exist. User interface terminal 22 enables an originator to enter applicant information into agent on-boarding system 12, update and add new rules or regulations to rules component 26, as well as perform other administrative functions. Other functions user interface 22 may allow an originator to perform relating to agent on-boarding include, but are not limited to: view, add, change, or delete rules; provide a free formatted notes or text area that allows the originator to document why a rule was modified; view, add, change, or delete persons authorized to maintain or view rules; provide the ability to search a particular rule; determine and modify the hierarchy of rules in rules component 26; provide the ability to key in a future date and/or time to enable a rule or provide an end date and/or time to disable a rule; audit all changes, additions, and deletions made to a rule; access who made any modifications to a rule, when the modifications where made, the function performed, and the value added, changed, or deleted; provide the ability to import and export a selected range of rules; provide a mean by which a rule or group of rules may be printed out; provide the ability to view, access, or report audit and capture information; provide the ability to archive old or deleted rules; and provide the ability to test new, modified, or deleted rules in an external environment.

The changes and/or updates may be applied in real time or can be set to activate at a future time. For example, rules component 26 may on occasion need to be updated to include rules specific to a particular country or a new regulation. User interface 22 allows an originator to communicate any rule update information to transaction processing system 20. Transaction processing system 20 subsequently updates rules component 26, in real time or at a scheduled time, as a function of the rule update information provided by the originator through user interface 22. In an exemplary embodiment, user interface 22 may be configured to recognize an administrator or a user at one of terminals 24A-24C.

Terminals 24A-24C

Terminals 24A-24C can be interfaced to transaction processing system 20 through conventional data and information communication ports and provides points of entry so that various administrators can access the information in transaction processing system 20. Transaction processing system 20 interfaces with point of entry terminals 24A-24C and provides information or instructions needed to complete a request on the screens or other interfaces of terminals 24A-24C. Each of terminals 24A-24C can also display and print informational messages. For example, agent on-boarding system 12 may indicate to the administrator on the screen of terminal 24A-24C information to be reviewed, whether an application has been approved, whether an application has been denied or whether more information is requested. Informational messages provided by transaction processing system 20 can also, for example, inform the administrator that the agent application has been forwarded on, has been denied or has been held pending additional information.

An administrator may also request information stored in agent on-boarding system 12 through terminals 24A-24C. In an exemplary embodiment, only a limited amount of information may be conveyed back to the administrator at terminal 24A-24C. For example, agent on-boarding system 12 may be set up such that only information that was entered at or prior to that administrator can be accessed by the administrator. Thus, if the administrator wants to check on the status of the agent application or whether additional information was added after the administrator has already completed his/her stage of the review, the administrator may need to contact the originator.

As the status of the agent application or the applicant's information may change during the agent application process, the ability to check the status of the agent application and change the applicant's information can be made available to the originator at least at user interface 16 and optionally also to administrators at terminals 24A-24C. For example, a pop-up/text field type function may be made available at user interface 22 and terminals 24A-24C to allow the originator or administrator to enter in new text.

Various telecommunications devices can be easily adapted for use as a point of entry, such as websites, cell phones or personal digital assistants. Although FIG. 2 depicts only one website terminal 24A, one cell phone terminal 24B and one personal digital assistant terminal 24C, agent on-boarding system 12 may include any number of terminals 24. Typically, a much larger (e.g., worldwide) network of websites, cell phones and personal digital assistants will have terminals such as 24A-24C. In an exemplary embodiment, user interface 22 may be configured to recognize the location of the terminal 24A-24C.

Rules Component 26

Each of subprocesses 30, 32, 34, 36 is connected to rules component 26 through transaction processing system 20 and is based on a set of on-boarding rules. Rules component 26 stores information defining the on-boarding rules associated with each subprocess 30, 32, 34, 36. The on-boarding rules within rules component 26 are generally pre-established using data elements supplied by an administrator. On-boarding rules can include, but are not limited to: approving a request, denying a request, holding a request and notifying the originator. Information representative of the on-boarding rules developed to determine how an application should be handled, for example, whether a requested agent application should be authorized, declined, or held, is configured within rules component 26 and is based in part on an administrator input.

One function of rules component 26 is to determine which on-boarding rules are applicable for a particular requested agent application. Rules component 26 includes a hierarchy of the on-boarding rules and determines applicable on-boarding rules based on administrator inputs.

Transaction processing system 20 can also have the ability to enable and disable on-boarding rules in rules component 26 (through user interface 22). Rules component 26 enables the definition and real-time enforcement of the on-boarding rules, including the ability to change existing rules and create new rules. In addition, the applicable on-boarding rules can be set for each state or country and can optionally be linked to the individual requirements or rules of each country.

Transaction Tool 28

Subprocesses 30, 32, 34, 36 and rules component 26 are connected to transaction tool 28 and carry out the on-boarding rules of rules component 26. In one embodiment, the on-boarding rules are associated with an on-boarding response which dictates where the applicant information is directed and how it is handled. Depending on the on-boarding rules determined to be applicable by rules component 26, transaction tool 28 will generate an appropriate on-boarding response. Exemplary on-boarding responses include, but are not limited to: forwarding data to a subsequent stage, sending the on-boarding request back to a previous stage, notifying the originator prompting the originator for additional information. For example, when the applicable on-boarding rule is to approve a request, the on-boarding request is forwarded on; when the applicable on-boarding rule is to deny a request, the originator is notified and the agent application is sent back to the originator; and when the applicable on-boarding rule is to hold a request, the originator is prompted for additional information.

In the embodiment shown in FIG. 2, when the on-boarding response is to forward on the agent application, transaction tool 28 sends the information on to the next stage. When the on-boarding response is to send the data back, transaction tool 28 sends a message back to the originator at user interface 22 to let the originator know that the request cannot be completed as submitted and sends the agent application back to the originator. When the on-boarding response is to prompt the originator for additional information, transaction tool 28 sends a message back to the originator to provide additional information. Transaction tool 28 thus initiates collection of information by prompting the originator at user interface 22 or through terminals 24A-24C to provide the requested information. The information collected is then sent back to the administrator for further review. One of the key features of transaction tool 28 is the ability to send information to various administrators and to process information in parallel.

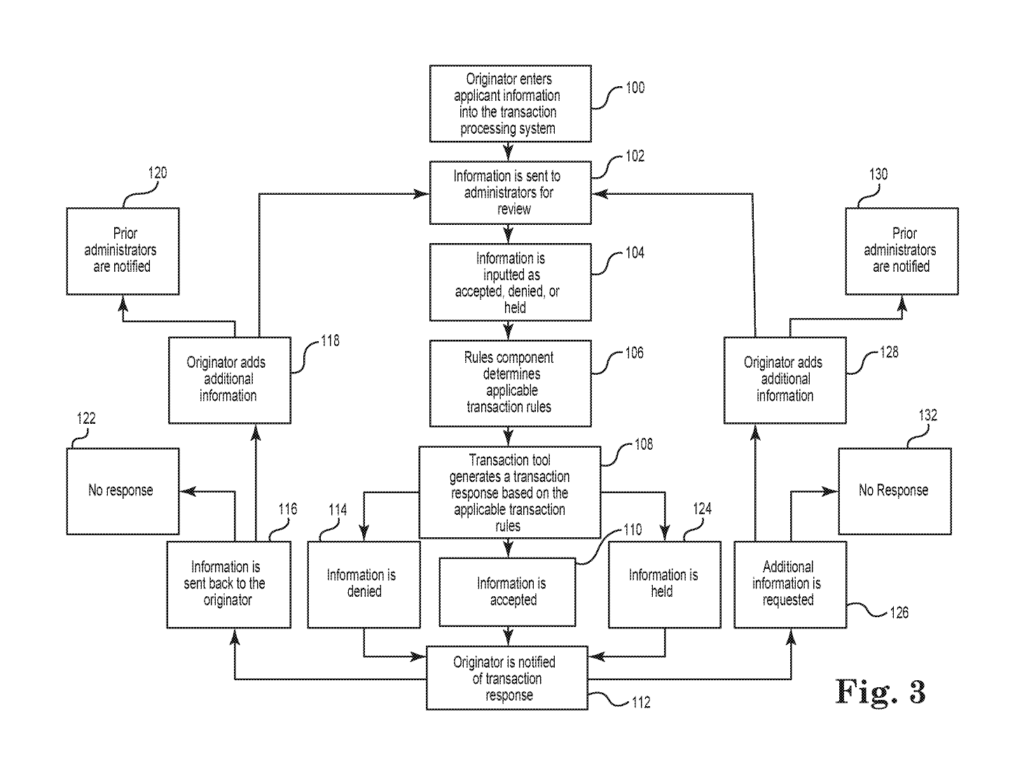

FIG. 3 is a flow diagram of the general operation of each of subprocesses 30, 32, 34, 36 for agent on-boarding system 12 within agent management system 10, according to one embodiment. Each of subprocesses 30, 32, 34, 36 function and interact with rules component 26 and transaction tool 28 in a similar manner. The general operation will thus be described with reference to all subprocesses 30, 32, 34, 36. To initiate the agent on-boarding process, an applicant first either manually or electronically fills out requested information which is subsequently sent to an originator who enters the information into transaction processing system 20 at user interface 22 (step 100). Once the information has been entered, the originator submits the agent application to transaction processing system 20 for approval from a group of administrators, or reviewers, who can view the information at one of terminals 24A-24C (step 102).

Subprocesses 30, 32, 34, 36 are directed by administrator inputs entered at one of terminals 24A-24C and are performed in series. After the administrator has reviewed the information, the administrator can decide to approve the agent application, deny the agent application, or hold the agent application pending additional information (step 104). The administrator inputs his/her response into one of terminals 24A-24C which is then sent to rules component 26 to determine the applicable on-boarding rules (step 106). Once the applicable on-boarding rules have been determined, transaction tool 28 analyzes the on-boarding responses or courses of action associated with the applicable on-boarding rules and causes the information to be sent to the appropriate location (step 108). The originator is also optionally notified each time an on-boarding response is generated (step 112). An on-boarding response authorizing sending the information to the next level in a hierarchy of administrators in the subsequent subprocess, as discussed below, is generated if the agent application has been approved (step 110).

In the embodiment shown in FIG. 3, an on-boarding response sending the agent application back to the originator is generated if the agent application has been denied (114). When the agent application has been denied, the originator is given an opportunity to modify and re-submit the agent application (116). When this occurs, a notification is optionally also sent to prior administrators who had previously approved the agent application (118, 120). If the originator declines to resubmit the agent application, the agent application ends (122).

Additional information may be required to determine whether an agent application should be allowed to proceed or whether an agent application should be denied. An on-boarding response requesting additional information can be generated if the agent application has been held because the information received is deficient (124). In this case, the agent application is returned to the originator at user interface 22 with a request for additional information (126). Once the additional information has been provided and uploaded into transaction processing system 20, the agent application is returned to point of entry terminal 24A-24C for review by the administrator (128). In addition, administrators that have previously approved the agent application can optionally be notified of the additional information (130). If the originator does not provide the requested information, the agent application ends (132).

Upon further review of the agent application with the additional information, the administrator inputs a response into point of entry terminal 24A-24C with which rules component 26 and transaction tool 28 generate an appropriate on-boarding response. In an exemplary embodiment, the agent application is also updated to reflect the status of the agent application.

In an exemplary embodiment, the agent application is submitted through subprocesses 30, 32, 34, 36 in the following order: proforma subprocess 30, analysis subprocess 32, agent set-up subprocess 34 and training subprocess 36. Thus, in this embodiment, prior to submitting the agent application to analysis subprocess 32, the agent application is first approved in proforma subprocess 30; prior to submitting the agent application to agent set-up subprocess 34, the agent application is first approved in analysis subprocess 32 (and therefore proforma subprocess 30); and prior to submitting the agent application to training subprocess 36, the agent application is first approved in agent set-up subprocess 34 (and therefore proforma subprocess 30 and analysis subprocess 32). However, within each subprocess 30, 32, 34, 36, multiple administrators are typically needed to approve the application. The agent application may optionally be simultaneously sent to each administrator for approval. Thus, while the agent application proceeds through the subprocesses 30, 32, 34, 36 linearly, the agent application can proceed through each subprocess 30, 32, 34, 36 non-linearly. In other embodiments, a subprocess may be skipped or at least two may be done at the same time.

Proforma Subprocess 30

During proforma subprocess 30, the proforma is submitted for prequalification approval. To launch proforma subprocess 30, an applicant either manually or electronically submits prequalification information including, for example: its doing-business-as name and main office address. The information is sent to the originator, who then enters the information into transaction processing system 20 for review. Once the prequalification form has been approved, the originator submits the proforma to an initial group of administrators.

As stated above, after the prequalification stage has been completed and all of the information has been entered for the agent application to proceed, the proforma is sent for approval by a different set of administrators. For example, the proforma is approved by a regional sales manager, chief financial officer and chief executive officer. The administrators have the ability to make changes to the proforma and send the proforma either backwards or forwards. In other embodiments, each time that the proforma is denied, it is sent back to the originator. As the proforma is approved at each stage, the next set of administrators, the originator and prior administrators are optionally notified. Notification is also optionally sent when the proforma is changed and saved.

Analysis Subprocess 32

In one embodiment, once the proforma has been approved, the information is sent to analysis subprocess 32 where an agent application is generated and processed and a risk analysis, compliance analysis of the applicant and a legal analysis are performed. The next set of administrators can approve, hold, save or reject the agent application. When an agent application is put on hold, the originator is informed of any deficiencies in the agent application and given an opportunity to provide any missing information. When an agent application is rejected, the agent application can be sent back to the originator to either modify and resubmit the agent application or to cancel the agent application.

In one embodiment, the originator may be given a time constraint in which to provide the information. When a time constraint is given, once the time constraint has passed, the agent application is sent back to the originator either for resubmission or cancellation.

If after review no issues or problems are found, the agent application can be approved. On the other hand, if serious issues or problems are found, the agent application is denied and sent back to the originator to either fix the agent application or end the agent application. When additional information is needed, the agent application may either be classified as pending or conditional. For example, if questionable information is found on the applicant, the agent application can be pended, if contradictory information (such as a different owner) is found on the applicant, then the agent application can be forwarded on with a conditional approval. Other reasons for denying or pending an agent application may include, but is not limited to, a discrepancy found regarding: the articles of incorporation, the articles of organization, the business license, a missing or invalid photograph identification, or proof of ownership. In all circumstances, the originator can optionally notified and prompted to provide additional information to complete the analysis.

Agent Set-Up Subprocess 34

In one embodiment, once the agent application has been reviewed and approved by the administrators in analysis subprocess 32, the new agent's information can be sent to agent set-up subprocess 34 for set-up by the sales department and the customer installation and set-up department. At agent set-up subprocess 34, the originator may set up an agent profile and equipment based on the information provided in the agent application. If the originator is unable to complete the agent set-up, the status may be noted as pending and sent back to the originator for completion. In some embodiments, the agent cannot be set up and processed until they have received a money transfer license. In this case, the originator may perform a partial set-up, activating some of the agent's access rights and activating the remaining access rights when the agent has received a license. Other reasons for holding or denying the agent set-up may include, but are not limited to: a blank contract, contract errors or an invalid driver's license. When an agent application is held due to contract errors, the agent application is optionally sent to accounting and settlement operations when determined by the legal department to escalate exception contractual terms.

Training Subprocess 36

The last step in this embodiment of agent on-boarding is to train the agent on anti-money laundering and the services and products that the agent will be providing. Other training that is deemed appropriate or desirable may also be available. In one embodiment, a trainer conducts the training via telephone. In another embodiment, the trainer may conduct the training on-line. During training process 36, a record may be kept in order to keep track of which agents have completed training. In one embodiment, the agent management system tracks the training requirements and may limit the agent's access to products and services until such training is completed.

In one embodiment, if the agent cannot currently receive training but sets up a future appointment, the trainer can enter the scheduled date and note that training has been rescheduled. Transaction processing system 20 then puts the agent in queue on the date the training is scheduled.

Although the present invention has been described with reference to preferred embodiments, those skilled in the art will recognize that changes can be made in form and detail without departing from the spirit and scope of the invention. In particular, although components of the transaction processing system are shown and described as different physical elements, these components can alternatively be different logical components of one or more common physical components of the system. Although described in connection with a money transfer system, the invention can also be used in connection with other products provided by the operator of the system, including bill pay, money orders, gift cards, etc.

The following is claimed:

1. A computer-implemented method for operating an agent portal of a money-transfer system, the method comprising:
receiving login information from a user attempting to access the agent portal, the agent portal providing money transfer services to its agents;
determining the user is an agent authorized to access the agent portal;
providing the agent with a user interface, wherein the user interface comprises one or more of the following icons:
a first icon whereupon selecting the first icon, the method comprises providing the agent access to a webpage including recent news and articles;
a second icon whereupon selecting the second icon, the method comprises providing the agent access to a webpage allowing the agent to configure the agent's profile;
a third icon whereupon selecting the third icon, the method comprises providing the agent access to a webpage including a list of the agent's transactions;
a fourth icon whereupon selecting the fourth icon, the method comprises providing the agent access to a webpage including a list of the agent's transactions;
a fifth icon whereupon selecting the fifth icon, the method comprises providing the agent access to training materials for the agent; and
a sixth icon whereupon selecting the sixth icon, the method comprises providing the agent access to a webpage including agent locations services.

2. The computer-implemented method of claim 1, wherein the user interface provided to the agent is based on the agent's location.

3. The computer-implemented method of claim 1, wherein the one or more icons provided on the user interface are based on the agent's profile.

4. The computer-implemented method of claim 1, wherein the one or more icons provided on the user interface are configurable by the agent.

5. The computer-implemented method of claim 1, wherein a layout of the one or more icons provided on the user interface is configurable by the agent.

6. The computer-implemented method of claim 1, wherein the user interface includes features customizable by the agent including color sets, banner graphics, or both.

7. The computer-implemented method of claim 1, wherein the agent portal comprises at least two of the following icons: the first icon, the second icon, the third icon, the fourth icon, the fifth icon, and the sixth icon.

8. The computer-implemented method of claim 7, wherein the agent portal comprises at least three of the following icons: the first icon, the second icon, the third icon, the fourth icon, the fifth icon, and the sixth icon.

9. The computer-implemented method of claim 1, further comprising:
determining when the agent has not complied with testing requirements;
blocking the agent's access to the money transfer services until the agent has complied with the testing requirements; and
providing the agent access to the training materials associated with the testing requirements.

10. The computer-implemented method of claim 9, further comprising providing the agent access to a testing module to determine the agent's compression of the training materials.

11. The computer-implemented method of claim 10, wherein the agent portal comprises all of the first icon, the second icon, the third icon, the fourth icon, the fifth icon, and the sixth icon.

12. An agent portal for a money-transfer system, the system comprising:
a user interface; and
a processor communicatively coupled to the user interface, the processor configured to:
receive, via the user interface, login information from a user attempting to access the agent portal, the agent portal providing money transfer services to agents associated with the money-transfer system;
determine the user is an agent authorized to access the agent portal; and
generate, on the user interface, one or more of the following icons:
a first icon whereupon selection of the first icon, the processor is configured to provide the agent access to a webpage including recent news and articles;
a second icon whereupon selection of the second icon, the processor is configured to provide the agent access to a webpage allowing the agent to configure the agent's profile;
a third icon whereupon selection of the third icon, the processor is configured to provide the agent access to a webpage including a list of the agent's transactions;
a fourth icon whereupon selection of the fourth icon, the processor is configured to provide the agent access to a webpage including a list of the agent's transactions;
a fifth icon whereupon selection of the fifth icon, the processor is configured to provide the agent access to training materials for the agent; and
a sixth icon whereupon selection of the sixth icon, the processor is configured to provide the agent access to a webpage including agent locations services.

13. The agent portal of claim 12, wherein the user interface generated by the processor is based on the agent's location.

14. The agent portal of claim 12, wherein the one or more icons generated by the processor are based on the agent's profile.

15. The agent portal of claim 1, wherein the one or more icons generated by the processor are configurable by the agent.

16. The agent portal of claim 1, wherein a layout of the one or more icons generated by the processor is configurable by the agent.

17. The agent portal of claim 1, wherein the user interface generated by the processor includes features customizable by the agent including color sets, banner graphics, or both.

18. The agent portal of claim 1, wherein the user interface generated by the processor comprises at least two of the following icons: the first icon, the second icon, the third icon, the fourth icon, the fifth icon, and the sixth icon.

19. The agent portal of claim 12, the processor configured to:
determine when the agent has not complied with testing requirements;
block the agent's access to the money transfer services until the agent has complied with the testing requirements; and
provide the agent access to the training materials associated with the testing requirements.

20. The agent portion of claim 19, the processor configured to generate a testing module to determine the agent's compression of the training materials.
